(19) United States
(12) Patent Application Publication
(10) Pub. No.: US 2006/0236882 A1
(43) Pub. Date: Oct. 26, 2006

(54) Device and method for cleaning a cylinder or a roller of a printing press

(76) Inventors: Claus-Dieter Barrois, Erlenbach (DE); Gunther Hoier, Veitschochheim (DE)

Correspondence Address: Clifford W Browning, 111 Moument Circle Bank One Center/Tower, Suite 3700, Indianapolis, IN, 46204-5137, US

(21) Appl. No.: 10/556,848

(22) PCT Filed: May 14, 2004
(86) PCT No.: PCT/CH04/00293

§ 371 Date: Nov. 14, 2005

(30) Foreign Application Priority Data
May 14, 2003 (DE) 103 21 804.1
Sep. 12, 2003 (DE) 103 42 496.2

(51) Int. Cl. B41F 35/00

(52) U.S. Cl. 101/425

(57) ABSTRACT

Device (01) and method for cleaning a cylinder (02) or a roller (02) of a printing machine using a cleaning agent web (03), wherein provided for the cleaning agent web (03) is a first supply roll (04) and a second supply roll (07), and wherein a winding device (06) for advancing the cleaning agent web (03) section by section can be driven in rotation. The radius of at least one supply roll (04; 07) is detected by a measuring device (19, 21) and the magnitude of the rotary movement of the winding device (06) as the cleaning agent web (03) is advanced section by section is changed as a function of the radius of the supply roll (04, 07).

The invention relates to a device and a method for cleaning a cylinder or a roller of a printing machine using a cleaning agent web, wherein provided for the cleaning agent web is a first supply roll for unwinding the cleaning agent web and a second supply roll for winding up the cleaning agent web, wherein a winding device for advancing the cleaning agent web section by section can be driven in rotation by a drive device, wherein a measuring device is provided which detects the radius of at least one supply roll and wherein an adjusting device is provided, whereby the magnitude of a respective rotary movement of the winding device can be changed as a function of the detected radius of the supply roll.

Such cleaning devices are used on printing machines to remove excess working media, for example excess printing ink, from a cylinder or a roller. The terms cylinder and roller are therefore intended to be used as synonyms in the text below.

DE 43 06 676 A1 discloses such a cleaning device comprising two spindles, wherein the supply roll with the clean cleaning agent web is mounted on one of the spindles and the waste roll with the used cleaning agent web is mounted on the other spindle. Electric motors are provided for driving the spindles, so that the cleaning agent web can be moved forward section by section in accordance with a control programme and finally can be wound back once the supply roll has been completely used.

U.S. Pat. No. 5,275,104 likewise discloses a cleaning device in which the waste roll is driven in steps and in continuous operation by an electric motor while the cleaning web is pneumatically pressed by a roller against a cylinder that is to be cleaned.

DE 41 42 422 A1 discloses a further cleaning device for guiding a cleaning agent web. In this device, the cleaning agent web is pressed against the appropriate cylinder by alternating pressure of the placing-against body, in order thereby to ensure an almost continuous advance movement.

One disadvantage of these known devices is that the advance movement of the cleaning agent web changes as a function of the radius of the waste roll. In the case of a waste roll with a large radius, this leads to more cleaning agent web being moved forward with each section-by-section advance movement of the cleaning agent web than is required to clean the roller or cylinder. This unnecessary consumption of cleaning agent web leads to relatively high operating costs.

Furthermore, U.S. Pat. No. 5,150,650 discloses a cleaning device of the type mentioned above in which the winding device for winding up the waste roll is pneumatically driven a number of times during each cleaning operation, in order thereby to ensure the advance movement of the cleaning agent web while the latter remains pressed in a circular arc against the cylinder that is to be cleaned. Each cleaning operation uses a large length of cleaning agent web.

The object of the invention is to provide a device and a method for cleaning a cylinder or a roller of a printing machine, wherein the consumption of cleaning agent web is kept as low as possible.

According to the invention, this object is achieved by a device of the aforementioned type in which the cleaning agent web can be pressed against the periphery of the cylinder or of the roller by means of a pressing device, wherein the pressing device can also be moved by means of the drive device between a placed-against working position and a moved-away rest position.

According to the invention, a method is provided wherein the cleaning agent web is unwound from a first supply roll and wound onto a second supply roll in a cyclical manner, wherein the cleaning agent web is transported forward by an approximately constant length in each operating cycle, wherein the cleaning agent web is moved in each operating cycle respectively between a working position in which it is placed against the cylinder or the roller and a rest position in which it is moved away therefrom, and wherein the respective forward transport takes place in only one direction of rotation exclusively during the placing-against movement or exclusively during the moving-away movement.

The teaching according to the invention is based on the fundamental concept that the radius of a roll, in particular of a waste roll, is detected so that the winding device for winding up the waste roll is then in each case rotated just far enough that the necessary running length of the cleaning agent web is wound up onto the periphery of the waste roll. During each cleaning operation, in each case only this running length is used and is replaced by a fresh length for the next operation. As a result, this means that the rotary movement of the winding device for each section-by-section advance of the cleaning agent web can be changed as a function of the radius of the waste roll. In the event of a small radius of the waste roll, the winding device must be moved by a relatively large angle of rotation in order to ensure the necessary advance of the cleaning agent web. In the event of a large radius of the waste roll, on the other hand, only a relatively small rotary movement of the winding device is necessary to ensure the corresponding advance of the cleaning agent web.

It is particularly advantageous here if the magnitude of the rotary movement of the winding device during the section-by-section advance of the cleaning agent web is changed in such a way that the length of the advanced section in each case remains approximately constant regardless of the radius of the waste roll. This measure ensures that in each case an advanced section with a constant length is moved forward, wherein the length of the advanced section is to be selected in such a way that a sufficient cleaning effect is achieved.

According to one preferred embodiment of the invention, the cleaning agent web is pressed against the periphery of the cylinder or of the roller by means of a pressing device which is designed in the manner of a pressing doctor blade. By virtue of this measure, the cleaning effect which can be achieved with the cleaning agent web is considerably increased and the consumption is reduced.

It should be possible for the pressing device to be moved between a placed-against working position and a moved-away rest position. This measure means that the cylinder or the roller is not cleaned continuously, but rather cleaning is carried out only when the pressing device is moved into the placed-against working position.

In order to achieve as simple a design as possible of the cleaning device, it is particularly advantageous if the winding device of the waste roll can also be driven in rotation directly or indirectly by the drive device for moving the pressing device. As a result, it is possible for both the winding device of the waste roll and the pressing device to be driven by only one drive device, for example a pneumatic or hydraulic control cylinder.

In order to be able to ensure an intermittent advance movement of the cleaning agent web between the different cleaning cycles, a freewheeling device may be provided between the drive device, for simultaneously driving the winding device and the pressing device, and the winding device of the waste roll. By virtue of this freewheeling device, the adjusting movement of the drive device is transmitted to the winding device in only one direction. In the other direction, the freewheel runs freely, so that the winding device is driven in only one direction of rotation.

Particularly simple cleaning devices can be implemented by using mechanical lever mechanisms. In order to ensure functioning thereof, it is then necessary for it to be possible for the effective lever length of the lever mechanism to be changed as a function of the radius of the waste roll. In other words, this means that the necessary change in the angle of driven rotation is ensured by changing the effective lever length of the lever mechanism.

Adjustment of the effective lever length of the lever mechanism may be carried out for example by an adjusting lever, with a track roller being mounted in a rotatable manner at one end of said adjusting lever, wherein the track roller comes to bear against the periphery of the waste roll. On account of the change in the radius of the waste roll, the position of this adjusting lever is then changed, wherein the effective lever length of the lever mechanism is influenced by the change in position of the adjusting lever.

One example of embodiment of the invention is shown in the drawings and will be described in more detail below.

In the drawings:

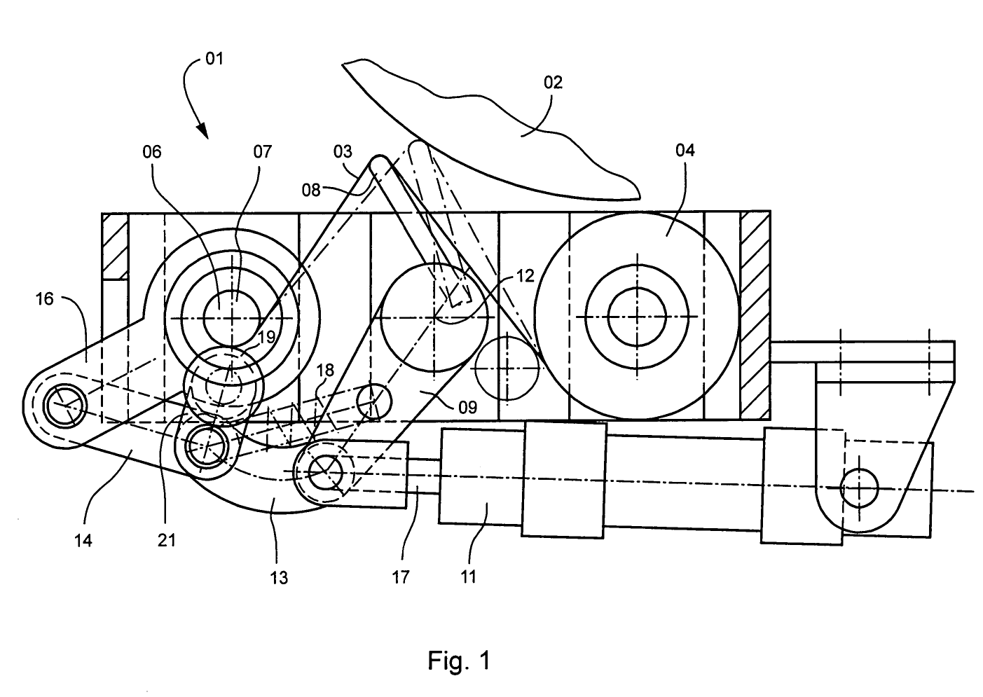

FIG. 1: shows a cleaning device in a first process condition, in a side view;

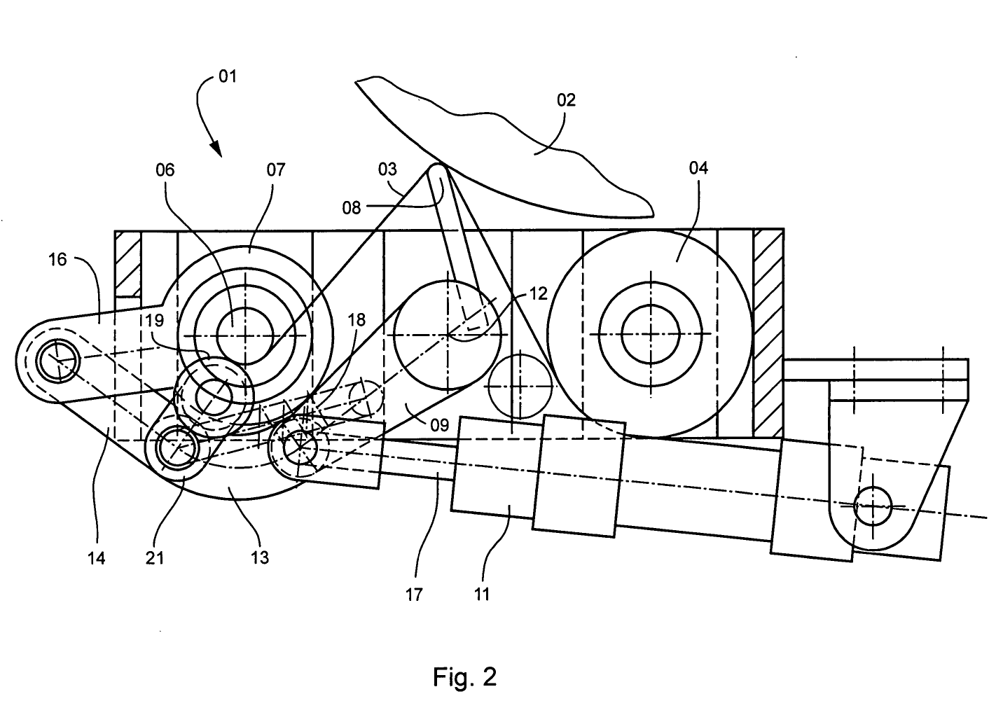

FIG. 2: shows the cleaning device of FIG. 1 in a second process condition;

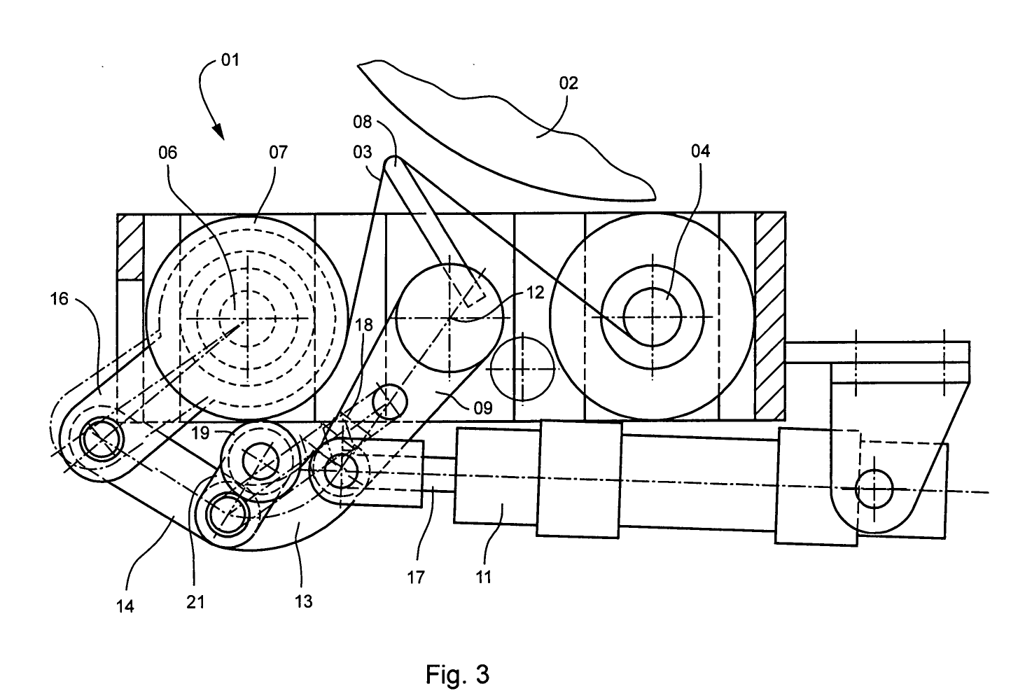

FIG. 3: shows the cleaning device of FIG. 1 in a third process condition;

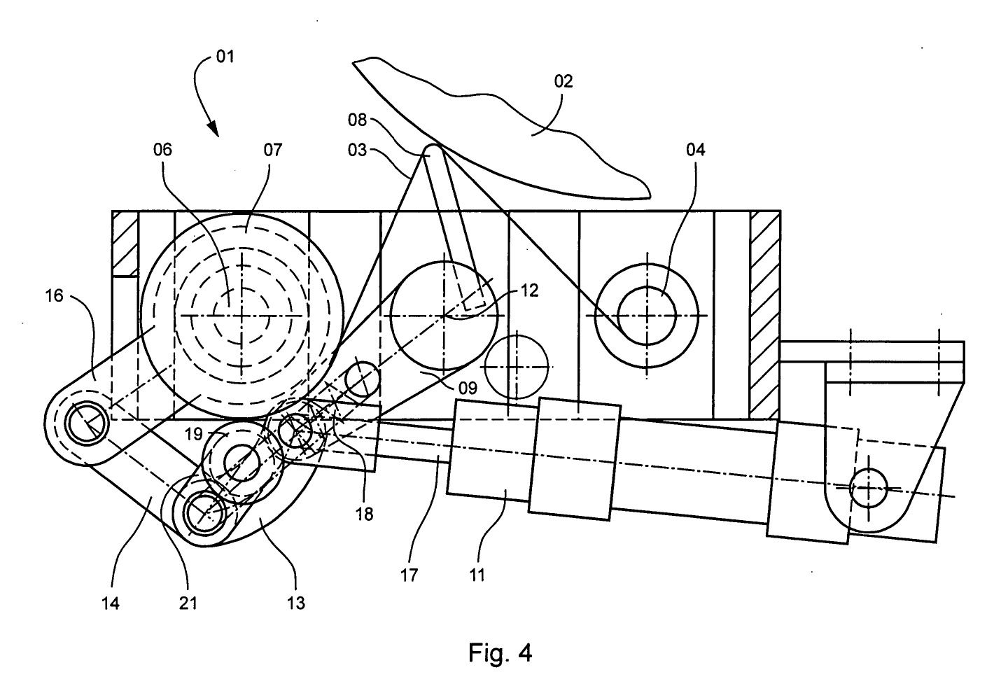

FIG. 4: shows the cleaning device of FIG. 1 in a fourth process condition;

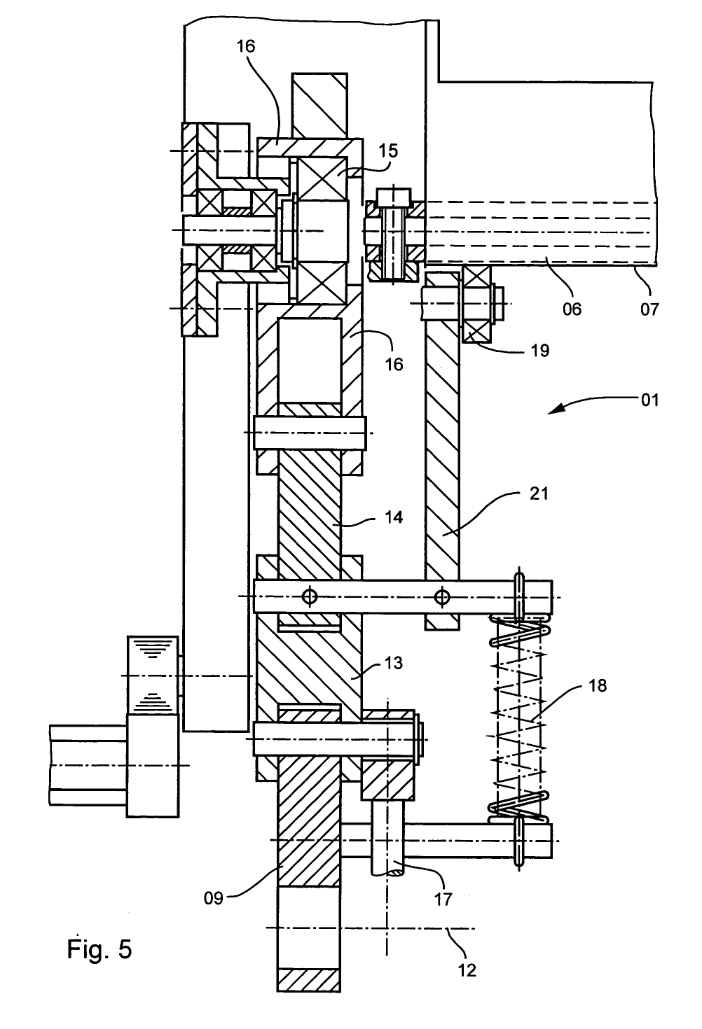

FIG. 5: shows the cleaning device of FIG. 1 in cross section from above.

The device 01 which is shown in FIG. 1, e.g. a cleaning device 01, serves to clean an ink roller 02 which is mounted in a stationary manner in an inking unit. In the device 01, a cleaning agent web 03, for example a web of cleaning paper or a cleaning cloth, is unwound from a supply roll 04. In order to advance the cleaning agent web 03, a winding device 06, for example a drive spindle 06, is intermittently driven in rotation, wherein, as a result, a second supply roll 07, in particular a waste roll 07, forms on the winding device 06. In the process condition shown in FIG. 1, the supply roll 04 has just been replaced and the waste roll 07 thus has its minimal radius, which essentially corresponds to the radius of the winding device 06.

In order to increase the cleaning effect of the cleaning agent web 03, the latter is guided over a pressing device 08 which is designed in the manner of a pressing doctor blade 08. The pressing device 08 is fixedly connected to an adjusting lever 09 which can be pivoted about an axis of rotation 12 by means of a drive device 11, which is designed in the manner of a pneumatic drive cylinder 11. On account of the pivoting of the adjusting lever 09, the pressing device 08 can be placed against the ink roller 02.

The drive device 11 acts on the winding device 06 via the adjusting levers 13, 14 and 16, which together form a lever mechanism. To this end, one end of the adjusting lever 16 comprises the winding device 06 with a freewheeling device 15. As a result, when the control rod 17 of the drive device 11 is moved out, the pressing device 08 is placed against the ink roller 02 and the associated rotary movement of the adjusting lever 16 is transmitted to the winding device 06, so that a piece of the cleaning agent web 03 is wound up onto the waste roll 07. A fresh section of the cleaning agent web 03 is thus available each time the cleaning agent web 03 is placed against the ink roller 02.

When the control rod 17 is then moved in again and the pressing device 08 is thus moved away, the freewheeling device 15 runs freely, so that the rotary movement of the adjusting lever 16 in the anticlockwise direction is not transmitted to the winding device 06.

In order to be able to ensure that the lever mechanism consisting of the adjusting levers 13, 14 and 16 bears without any play at all times, a spring element 18, in particular a tension spring 18, is provided between the adjusting lever 09 and the joining axle between the adjusting levers 13 and 14.

The diameter of the waste roll 07 is detected by a track roller 19 which is mounted in a rotatable manner at the end of an adjusting lever 21. The other end of the adjusting lever 21 is connected to the joining axle between the adjusting levers 13 and 14. Depending on the radius of the waste roll 07, the adjusting lever 21 migrates downwards or upwards and as a result accordingly changes the effective lever length of the lever mechanism formed of the adjusting levers 13, 14 and 16.

FIG. 2 shows the device 01 in the following process step, once the control rod 17 has been moved out. On account of the movement of the adjusting lever 16 in the clockwise direction, a piece of the cleaning agent web 03 has been wound up onto the waste roll 07 and thus the cleaning agent web has been moved forward. At the same time, the pressing device 08 has been placed against the inking roller 02 by pivoting the adjusting lever 09 in the clockwise direction. In FIG. 1, the position of the adjusting lever 16 in the process condition of FIG. 2 is shown in dashed line. It can be seen that, as the control rod 17 is moved out, the adjusting lever 16 is pivoted through a relatively large angle on account of the relatively large effective lever length of the lever mechanism. As a result, the advanced length when the cleaning agent web 03 is moved forward, which results from the radius of the waste roll 07 and the pivoting angle of the adjusting lever 16, is retained to a sufficiently large extent despite the relatively small radius of the waste roll 07.

FIG. 3 shows the device 01 in a process condition in which the supply roll 04 has almost completely been used up and the waste roll 07 has an accordingly large radius. At the same time, the control rod 17 is moved in and thus the pressing device 08 is moved away from the ink roller 02.

On account of the large radius of the waste roll 07, the adjusting lever 21 is pushed far downwards, as a result of which the effective lever length of the lever mechanism consisting of the adjusting levers 13, 14 and 16 is accordingly reduced.

FIG. 4 shows the device 01 in the process condition following that of FIG. 3, once the pressing device 08 has been placed against the ink roller 02 by moving the control rod 17 out. It can be seen that the reduction in the effective lever length of the lever mechanism means that, when the control rod 17 is completely moved out, the adjusting lever 16 is driven in the clockwise direction only through a relatively small angle. This therefore ensures that, despite the relatively large radius of the waste roll 07, the cleaning agent web 03 is moved forward only by a length section whose length corresponds approximately to the length of the advanced section during the advance movement between the process conditions shown in FIG. 1 and FIG. 2. That is to say that the movement of the adjusting lever 21 means that, despite the constant adjustment movement of the drive device 11 and despite the increase in the radius of the waste roll 07, the advanced length can be kept essentially constant.

FIG. 5 shows the various parts of the device 01 in cross section from above, wherein the various parts are not shown to relative scale on account of the offset nature of the drawing.

### LIST OF REFERENCES

01 device, cleaning device
02 roller, cylinder, ink roller
03 cleaning agent web
04 supply roll
05 -
06 winding device, drive device
07 supply roll, waste roll
08 pressing device, pressing doctor blade
09 adjusting lever
10 -
11 drive device, drive cylinder
12 axis of rotation
13 adjusting lever
14 adjusting lever
15 freewheeling device
16 adjusting lever
17 control rod
18 spring element, tension spring
19 track roller
20 -
21 adjusting lever

1-14. (canceled)

15. Device for cleaning a cylinder or a roller of a printing machine using a cleaning agent web, wherein provided for the cleaning agent web is a first supply roll for unwinding the cleaning agent web and a second supply roll for winding up the cleaning agent web, wherein a winding device for advancing the cleaning agent web section by section can be driven in rotation by a drive device, wherein a measuring device is provided which detects the radius of at least one supply roll and wherein an adjusting device is provided, whereby the magnitude of a respective rotary movement of the winding device can be changed as a function of the detected radius of the supply roll, wherein the cleaning agent web can be pressed against the periphery of the cylinder or of the roller by means of a pressing device, and wherein the pressing device can also be moved by means of the drive device between a placed-against working position and a moved-away rest position.

16. Device according to claim 15, wherein the measuring device detects the radius of the second supply roll.

17. Device according to claim 16, wherein the adjusting device is designed so that the magnitude of a rotary movement of the winding device is changed in such a way that the length of a respective advanced section remains approximately constant regardless of the radius of the second supply roll.

18. Device according to claim 15, wherein the pressing device is designed in the manner of a pressing doctor blade which can be pivoted by means of the drive device.

19. Device according to claim 15, wherein a freewheeling device is provided between the drive device and the winding device of the second supply roll, so that the second supply roll is driven in just one direction of rotation exclusively during the placing-against movement or exclusively during the moving-away movement of the pressing device.

20. Device according to claim 19, wherein a lever mechanism comprising at least two adjusting levers is provided between the drive device and the freewheeling device, and wherein the effective lever length of the lever mechanism can be changed as a function of the radius of the second supply roll.

21. Device according to claim 20, wherein an adjusting lever which serves as the measuring device is provided on the lever mechanism, with a track roller being mounted in a rotatable manner at one end of said adjusting lever, wherein the track roller can come to bear against the periphery of the second supply roll and, in the event of a change in the radius of the second supply roll, the effective lever length of the lever mechanism of the second supply roll can be changed by adjusting the adjusting lever.

22. Device according to claim 15, wherein the drive device is designed in the manner of a hydraulic or pneumatic drive cylinder, the control rod of which acts on the lever mechanism.

23. Device according to claim 15, wherein the pressing device is fixedly connected to an adjusting lever which can be pivoted by means of the drive device.

24. Device according to claim 20, wherein the lever mechanism is prestressed by a spring element.

25. Device according to claim 21, wherein the lever mechanism is prestressed by a spring element.

26. Device according to claim 22, wherein the lever mechanism is prestressed by a spring element.

27. Device according to claim 23, wherein the lever mechanism is prestressed by a spring element.

28. Device according to claim 27, wherein the spring element is provided between the adjusting lever, which is fixedly connected to the pressing device, and the lever mechanism.

29. Device according to claim 15, wherein the cleaning agent web can be placed against a roller, in particular a stationary roller of an inking unit.

30. Method for cleaning a cylinder or a roller of a printing machine using a cleaning agent web, wherein the cleaning agent web is unwound from a first supply roll and wound onto a second supply roll in a cyclical manner, wherein the cleaning agent web is transported forward by an approximately constant length in each operating cycle, and wherein the cleaning agent web is moved in each operating cycle respectively between a working position in which it is placed against the cylinder or the roller and a rest position in which it is moved away therefrom, and wherein the respective forward transport takes place in just one direction of rotation exclusively during the placing-against movement or exclusively during the moving-away movement.

31. Method according to claim 30, wherein the respective forward transport takes place during the movement from the moved-away rest position into the placed-against working position.
